(19) United States
(12) Patent Application Publication
(10) Pub. No.: US 2026/0082191 A1
(43) Pub. Date: Mar. 19, 2026

(54) INFORMATION TRANSMISSION METHOD AND APPARATUS, AND STORAGE MEDIUM

(71) Applicant: Beijing Xiaomi Mobile Softwate Co., Ltd., Beijing (CN)

(72) Inventor: Wei HONG, Beijing (CN)

(21) Appl. No.: 19/106,569

(22) PCT Filed: Sep. 2, 2022
(86) PCT No.: PCT/CN2022/116889

§ 371 Date: Feb. 25, 2025

(51) Int. Cl. H04W 4/44; H04B 7/185; H04W 76/00

(52) U.S. Cl. CPC H04W 4/44; H04B 7/18506; H04W 76/00

(57) ABSTRACT

An information transmission method is performed by an unmanned aerial vehicle and includes: reporting a first notification message to a base station, wherein the first notification message is configured to notify the base station that the unmanned aerial vehicle stores flight path information.

### CROSS REFERENCE TO RELATED APPLICATIONS

This application is the US National Phase of International Application No. PCT/CN2022/116889, filed on Sep. 2, 2022, the entire contents of which are incorporated herein by reference.

### TECHNICAL FIELD

The present disclosure relates to the field of communication technologies, and in particular to information transmission methods and apparatuses, and storage mediums.

### BACKGROUND

A pilotless aircraft is also called an unmanned aerial vehicle (UAV), and is manipulated through a radio remote control equipment and a self-equipped program control device. The UAV is actually a collective term for the pilotless aircrafts. From technical views, UAVs can be classified into: an unmanned fixed-wing aircraft, an unmanned vertical take-off and a landing aircraft, an unmanned airship, an unmanned helicopter, an unmanned multi-rotor aircraft, an unmanned parafoil aircraft, etc. The UAV control terminal is a terminal capable of controlling a UAV remotely.

With the development of UAV technologies, cost reduction and function improvement, UAVs are increasingly used in the lives of ordinary consumers. Industrial applications are the real immediate needs for the UAVs. With the rapid development of UAV technology, UAV has been widely used in various fields, such as aerial photography, agriculture, vegetation conservation, micro self-portrait, express transportation, disaster relief, observations of wildlife, surveillance of infectious diseases, surveying and mapping, news reports, power inspections, filming and etc. The use of the UAV is greatly expanded. Various countries are actively expanding the industrial applications of UAV and developing the UAV technology.

In order to further expand the application scope of UAV, the 3rd Generation Partnership Project (3GPP) approved the project of enhanced support for aerial vehicles. This aims to study and standardize enabling cellular networks to provide services for UAVs to meet demand.

The UAV generally has two modes. One mode is a fixed mode, which means that the controller will plan the flight path of the UAV on the controller, so that the UAV can follow the planned path, and the controller does not have to control the UAV all the time. The other mode is a dynamic mode, that is, the controller will remotely control the UAV in real time through the controller at all times. For the fixed mode, the cellular network can predict which cellular network base stations the UAV will pass through since the flight path and trajectory of the UAV is fixed.

### SUMMARY

According to a first aspect of the embodiments of the present disclosure, there is provided an information transmission method, performed by an unmanned aerial vehicle (UAV), and including: reporting a first notification message to a base station, where the first notification message is configured to notify the base station that the unmanned aerial vehicle stores flight path information.

In some embodiments, reporting the first notification message to the base station includes: reporting, by first radio resource control (RRC) signaling, the first notification message to the base station.

In some embodiments, reporting, by the first RRC signaling, the first notification message to the base station includes: reporting, by a first information unit in the first RRC signaling, the first notification message to the base station.

In some embodiments, reporting, by the first RRC signaling, the first notification message to the base station includes: reporting, by a designated information unit in the first information unit, the first notification message to the base station, where the designated information unit is configured to indicate that the flight path information is available.

In some embodiments, the designated information unit is of enumerated type.

In some embodiments, in a case that the base station is a new radio (NR) base station, the first RRC signaling is any one of:
RRC reconfiguration complete (e.g., RRCReconfigurationComplete) signaling;
RRC reestablishment complete (e.g., RRCReestablishmentComplete) signaling;
RRC resume complete (e.g., RRCResumeComplete) signaling; and
RRC setup complete (e.g., RRCSetupComplete) signaling.

In some embodiments, the method further includes: receiving a request message transmitted by the base station, where the request message is configured to request the unmanned aerial vehicle to report the flight path information; and reporting, based on the request message, the flight path information to the base station.

In some embodiments, receiving the request message transmitted by the base station includes: receiving the request message transmitted, through second RRC signaling, by the base station.

In some embodiments, the second RRC signaling carries configuration information for the unmanned aerial vehicle to report the flight path information; where reporting the flight path information to the base station includes: reporting the flight path information to the base station as indicated by the configuration information.

In some embodiments, the configuration information is configured to indicate at least one of: a maximum number of path points allowed to be reported by the unmanned aerial vehicle; or a time stamp of the unmanned aerial vehicle at each path point.

In some embodiments, the configuration information is carried in a second information unit of the second RRC signaling.

In some embodiments, the second RRC signaling is terminal information request (e.g., UEInformationRequest) signaling.

In some embodiments, reporting the flight path information to the base station includes: reporting, by third RRC signaling, the flight path information to the base station.

In some embodiments, reporting, by the third RRC signaling, the flight path information to the base station includes: reporting, by a third information unit in the first RRC signaling, the flight path information to the base station.

In some embodiments, reporting the flight path information to the base station includes: reporting the flight path information corresponding to the maximum number of path points to the base station in response to a total number of path points corresponding to the flight path information stored by the unmanned aerial vehicle being greater than the maximum number of path points; where the method further includes: reporting a second notification message to the base station, where the second notification message is configured to notify the base station that the unmanned aerial vehicle stores unreported flight path information.

In some embodiments, the second notification message is carried in the third RRC signaling, and the third RRC signaling is for the unmanned aerial vehicle to report the flight path information to the base station.

In some embodiments, reporting the second notification message to the base station includes: reporting, by a designated information unit in the third information unit of the third RRC signaling, the second notification message to the base station, where the third information unit is configured to report the flight path information, and the designated information unit is configured to indicate that the flight path information is available.

In some embodiments, the third RRC signaling is terminal information response (e.g., UEInformationResponse) signaling.

In some embodiments, the method further includes: receiving a new request message transmitted, based on the second notification message, by the base station, where the new request message is configured to request the unmanned aerial vehicle to report the flight path information; and reporting, based on the new request message, previously unreported flight path information to the base station.

According to a second aspect of the embodiments of the present disclosure, there is provided an information transmission method, performed by a base station, and including: receiving a first notification message reported by an unmanned aerial vehicle, where the first notification message is configured to notify the base station that the unmanned aerial vehicle stores flight path information.

In some embodiments, receiving the first notification message reported by an unmanned aerial vehicle includes: receiving the first notification message reported, through first radio resource control (RRC) signaling, by the unmanned aerial vehicle.

In some embodiments, receiving the first notification message reported, through the first RRC signaling, by the unmanned aerial vehicle includes: receiving the first notification message reported, through a first information unit in the first RRC signaling, by the unmanned aerial vehicle.

In some embodiments, the method further includes: determining, based on a designated information unit in the first information unit, that the first notification message is received, where the designated information unit is configured to indicate that the flight path information is available.

In some embodiments, the designated information unit is of enumerated type.

In some embodiments, in a case that the base station is a new radio (NR) base station, the first RRC signaling is any one of:
RRC reconfiguration complete (e.g., RRCReconfigurationComplete) signaling;
RRC reestablishment complete (e.g., RRCReestablishmentComplete) signaling;
RRC resume complete (e.g., RRCResumeComplete) signaling; and
RRC setup complete (e.g., RRCSetupComplete) signaling.

In some embodiments, the method further includes: transmitting, based on the first notification message, a request message to the unmanned aerial vehicle, where the request message is configured to request the unmanned aerial vehicle to report the flight path information; and receiving the flight path information reported by the unmanned aerial vehicle.

In some embodiments, transmitting a request message to the unmanned aerial vehicle includes: transmitting, by second RRC signaling, the request message to the unmanned aerial vehicle.

In some embodiments, the second RRC signaling carries configuration information for the unmanned aerial vehicle to report the flight path information.

In some embodiments, the configuration information is configured to indicate at least one of: a maximum number of path points allowed to be reported by the unmanned aerial vehicle; or a time stamp of the unmanned aerial vehicle at each path point.

In some embodiments, the configuration information is carried in a second information unit of the second RRC signaling.

In some embodiments, the second RRC signaling is terminal information request (e.g., UEInformationRequest) signaling.

In some embodiments, receiving the flight path information reported by the unmanned aerial vehicle includes: receiving the flight path information reported, through third RRC signaling, by the unmanned aerial vehicle.

In some embodiments, receiving the flight path information reported, through the third RRC signaling, by the unmanned aerial vehicle includes: receiving the flight path information reported, through a third information unit in the third RRC signaling, by the unmanned aerial vehicle.

In some embodiments, the method further includes: receiving a second notification message reported by the unmanned aerial vehicle, where the second notification message is configured to notify the base station that the unmanned aerial vehicle stores unreported flight path information.

In some embodiments, the second notification message is carried in the third RRC signaling, and the third RRC signaling is for the unmanned aerial vehicle to report the flight path information to the base station.

In some embodiments, the method further includes: determining, based on a designated information unit in the third information unit of the third RRC signaling, the second notification message is received, where the third information unit is configured to report the flight path information, and the designated information unit is configured to indicate that the flight path information is available.

In some embodiments, the third RRC signaling is terminal information response (e.g., UEInformationResponse) signaling.

In some embodiments, the method further includes: transmitting, based on the second notification message, a new request message to the unmanned aerial vehicle, where the new request message is configured to request the unmanned aerial vehicle to report the flight path information; and receiving the flight path information reported, based on the new request message, by the unmanned aerial vehicle.

According to a third aspect of embodiments of the present disclosure, there is provided a non-transitory computer-readable storage medium, storing computer programs thereon, where the computer programs, when executed by a processor, cause the processor to perform the information transmission method of any one of the embodiments of the unmanned aerial vehicle side.

According to a fourth aspect of embodiments of the present disclosure, there is provided a non-transitory computer-readable storage medium, storing computer programs thereon, where the computer programs, when executed by a processor, cause the processor to perform the information transmission method of any one of the embodiments of the base station side.

According to a fifth aspect of the embodiments of the present disclosure, there is provided an information transmission device including: a processor; and a memory storing instructions executable by the processor; where the instructions, when executed by the processor, cause the processor to perform the information transmission method of any one of the embodiments of the unmanned aerial vehicle side.

According to a sixth aspect of the embodiments of the present disclosure, there is provided an information transmission device including: a processor; and a memory storing instructions executable by the processor; where the instructions, when executed by the processor, cause the processor to perform the information transmission method of any one of the embodiments of the base station side.

It is to be understood that the above general descriptions and the below detailed descriptions are merely exemplary and explanatory, and are not intended to limit the present disclosure.

### BRIEF DESCRIPTION OF THE DRAWINGS

The accompanying drawings herein, which are incorporated in and constitute a part of the present description, illustrate examples consistent with the present disclosure and serve to explain the principles of the present disclosure together with the description.

FIG. 1 is a flowchart illustrating an information transmission method according to an embodiment of the present disclosure.

FIG. 2 is a flowchart illustrating an information transmission method according to another embodiment of the present disclosure.

FIG. 3 is a flowchart illustrating an information transmission method according to yet another embodiment of the present disclosure.

FIG. 4 is a flowchart illustrating an information transmission method according to still another embodiment of the present disclosure.

FIG. 5 is a flowchart illustrating an information transmission method according to still another embodiment of the present disclosure.

FIG. 6 is a flowchart illustrating an information transmission method according to still another embodiment of the present disclosure.

FIG. 7 is a flowchart illustrating an information transmission method according to still another embodiment of the present disclosure.

FIG. 8 is a flowchart illustrating an information transmission method according to still another embodiment of the present disclosure.

FIG. 9 is a flowchart illustrating an information transmission method according to still another embodiment of the present disclosure.

FIG. 10 is a flowchart illustrating an information transmission method according to still another embodiment of the present disclosure.

FIG. 11 is a flowchart illustrating an information transmission method according to still another embodiment of the present disclosure.

FIG. 12 is a flowchart illustrating an information transmission method according to still another embodiment of the present disclosure.

FIG. 13 is a flowchart illustrating an information transmission method according to still another embodiment of the present disclosure.

FIG. 14 is a flowchart illustrating an information transmission method according to still another embodiment of the present disclosure.

FIG. 15 is a flowchart illustrating an information transmission method according to still another embodiment of the present disclosure.

FIG. 16 is a flowchart illustrating an information transmission method according to still another embodiment of the present disclosure.

FIG. 17 is a block diagram illustrating an information transmission apparatus according to an embodiment of the present disclosure.

FIG. 18 is a block diagram illustrating an information transmission apparatus according to another embodiment of the present disclosure.

FIG. 19 is a structural schematic diagram illustrating an information transmission device according to an embodiment of the present disclosure.

FIG. 20 is a structural schematic diagram illustrating an information transmission device according to another embodiment of the present disclosure.

### DETAILED DESCRIPTION OF THE EMBODIMENTS

Examples will be described in detail herein, with the illustrations thereof represented in the drawings. Where the following description relates to the drawings, unless otherwise indicated, the same numerals in different drawings represent the same or similar elements. Implementations described in the following examples do not represent all implementations consistent with the present disclosure. On the contrary, they are examples of an apparatus and a method consistent with some aspects of the present disclosure described in detail in the appended claims.

The terminology used herein is for the purpose of describing particular embodiments only and is not intended to be limiting of the present disclosure. As used herein, the singular forms “a”, “said” and “the” are intended to include the plural forms as well, unless the context clearly indicates otherwise. It will also be understood that as used herein, the term “and/or” is and includes any or all combinations of one or more of the associated listed items.

It will be understood that while terms such as “first”, “second”, “third”, etc. may be used to describe to describe various information, such information should not be limited to these terms. These terms are used only to distinguish the same type of information from each other. For example, without departing from the scope of the present disclosure, a first information may also be referred to as a second information, and similarly, a second information may also be referred to as a first information. Depending on the context, as used herein, the wording “if” may be interpreted as “while . . . ” or “when . . . ” or “in response to a determination”.

The information transmission method provided by the present disclosure is described below from the unmanned aerial vehicle side.

An embodiment of the present disclosure provides an information transmission method, which can be performed by an unmanned aerial vehicle. FIG. 1 is a flowchart illustrating the information transmission method according to the embodiment of the present disclosure. As shown in FIG. 1, the method can include the following step 101.

At step S101, a first notification message is reported to a base station, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the unmanned aerial vehicle may report the first notification message to the base station during the establishment of a radio resource control (RRC) connection with the base station, and the first notification message is configured to notify the base station that the flight path information is stored on the unmanned aerial vehicle.

In the embodiments, the unmanned aerial vehicle can report the first notification message to the base station to notify the base station that the unmanned aerial vehicle has flight path information, so that the base station can obtain complete flight path information from the unmanned aerial vehicle, thereby the feasibility of providing services for the unmanned aerial vehicle by the cellular network is improved.

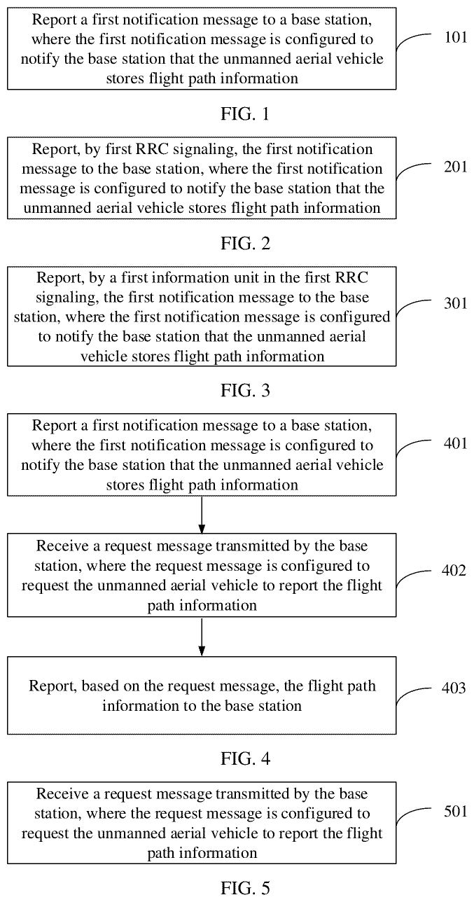

In some embodiments, an information transmission method is provided. FIG. 2 is a flowchart illustrating the information transmission method according to an embodiment of the present disclosure. The method is performed by the unmanned aerial vehicle. As shown in FIG. 2, the method can include the following step 201.

At step S201, a first notification message is reported to a base station by first RRC signaling, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the unmanned aerial vehicle may report the first notification message to the base station by the first RRC signaling during the establishment of a RRC connection with the base station, and the first notification message is configured to notify the base station that the flight path information is stored on the unmanned aerial vehicle.

In some embodiments, the base station may be a new radio (NR) base station, or a long term evolution (LTE) base station, which is not limited by this disclosure.

In some embodiments, the base station is an NR base station, and accordingly, the first RRC signaling is any one of: RRC reconfiguration complete (e.g., RRCReconfigurationComplete) signaling; RRC reestablishment complete (e.g., RRCReestablishmentComplete) signaling; RRC resume complete (e.g., RRCResumeComplete) signaling; and RRC setup complete (e.g., RRCSetupComplete) signaling.

In the embodiments, the unmanned aerial vehicle can report, by the first RRC signaling, the first notification message to the base station to notify the base station that the unmanned aerial vehicle has flight path information, so that the base station can obtain complete flight path information from the unmanned aerial vehicle, thereby the feasibility of providing services for the unmanned aerial vehicle by the cellular network is improved.

In some embodiments, an information transmission method is provided. FIG. 3 is a flowchart illustrating the information transmission method according to an embodiment of the present disclosure. The method is performed by the unmanned aerial vehicle. As shown in FIG. 3, the method can include the following step 301.

At step S301, a first notification message is reported to a base station by a first information unit in the first RRC signaling, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto. In some embodiments, the unmanned aerial vehicle may report the first notification message to the base station by the first RRC signaling during the establishment of a RRC connection with the base station, and the first notification message is configured to notify the base station that the flight path information is stored on the unmanned aerial vehicle.

In some embodiments, the base station may be a NR base station, or a LTE base station, which is not limited by the present disclosure.

In some embodiments, the base station is an NR base station, and accordingly, the first RRC signaling is any one of RRCReconfigurationComplete signaling; RRCReestablishmentComplete) signaling; RRCResumeComplete signaling; and RRCSetupComplete signaling.

In some embodiment, the first information unit is an information element (IE) newly introduced in the protocol, and the first information unit may be related to flight path information. For example, the first RRC signaling is RRCSetupComplete signaling, and correspondingly, the first information unit can be RRCSetupComplete-v1800-IEs.

In some embodiment, the unmanned aerial vehicle can report the first notification message to the base station through a designated information unit in the first information unit. In a case that the base station determines that the designated information unit is included in the first information unit of the first RRC signaling, the base station determines that the first notification message is received, that is, it is determined that the unmanned aerial vehicle stores the flight path information.

In some embodiments, the designated information unit may be configured to indicate that the flight path information is available. In some embodiments, the designated information unit may be a flightPathInfoAvailable-r18 information unit.

In some embodiments, the designated information unit is of enumerated type.

In the case that the first RRC signaling is RRCSetupComplete signaling. The first notification message is reported to the base station through the designated information unit (e.g., flightPathInfoAvailable-r18) of enumerated type in the first information unit (e.g., RRCSetupComplete-v1800-IEs) of the first RRC signaling. The specific implementation is as follows:

RRCSetupComplete message

-- ASN1START
-- TAG-RRCSETUPCOMPLETE-START

| | |
|---|---|
| RRCSetupComplete ::= | SEQUENCE { |
| rrc-TransactionIdentifier | RRC-TransactionIdentifier, |
| criticalExtensions | CHOICE { |
| rrcSetupComplete | RRCSetupComplete-IEs, |
| criticalExtensionsFuture | SEQUENCE { } |

}
}

| RRCSetupComplete-IEs ::= | SEQUENCE { | |
|---|---|---|
| selectedPLMN-Identity | INTEGER (1..maxPLMN), | |
| registeredAMF | RegisteredAMF | OPTIONAL, |
| guami-Type | ENUMERATED {native, mapped} | OPTIONAL, |
| s-NSSAI-List | SEQUENCE (SIZE (1..maxNrofS-NSSAI)) OF S-NSSAI | OPTIONAL, |
| dedicatedNAS-Message | DedicatedNAS-Message, | |
| ng-5G-S-TMSI-Value | CHOICE { | |
| ng-5G-S-TMSI | NG-5G-S-TMSI, | |
| ng-5G-S-TMSI-Part2 | BIT STRING (SIZE (9)) | |
| } | | OPTIONAL, |
| lateNonCriticalExtension | OCTET STRING | OPTIONAL, |
| nonCriticalExtension | RRCSetupComplete-v1610-IEs | OPTIONAL |

}

| RRCSetupComplete-v1610-IEs ::= | SEQUENCE { | |
|---|---|---|
| iab-NodeIndication-r16 | ENUMERATED {true} | OPTIONAL, |
| idleMeasAvailable-r16 | ENUMERATED {true} | OPTIONAL, |
| ue-MeasurementsAvailable-r16 | UE-MeasurementsAvailable-r16 | OPTIONAL, |
| mobilityHistoryAvail-r16 | ENUMERATED {true} | OPTIONAL, |
| mobilityState-r16 | ENUMERATED {normal, medium, high, spare} | OPTIONAL, |
| nonCriticalExtension | RRCSetupComplete-v1700-IEs | OPTIONAL |

}

| RRCSetupComplete-v1700-IEs ::= | SEQUENCE { | |
|---|---|---|
| onboardingRequest-r17 | ENUMERATED {true} | OPTIONAL, |
| nonCriticalExtension | RRCSetupComplete-v1800-IEs | OPTIONAL |

}

| RRCSetupComplete-v1800-IEs ::= | SEQUENCE { | |
|---|---|---|
| flightPathInfoAvailable-r18 | ENUMERATED {true} | OPTIONAL, |
| nonCriticalExtension | SEQUENCE{ } | OPTIONAL |

}

| RegisteredAMF ::= | SEQUENCE { | |
|---|---|---|
| plmn-Identity | PLMN-Identity | OPTIONAL, |

| | |
|---|---|
| amf-Identifier | AMF-Identifier |

}
-- TAG-RRCSETUPCOMPLETE-STOP
-- ASN1STOP

In the case that the first RRC signaling is any one of RRCReconfigurationComplete signaling, RRCReestablishmentComplete signaling and RRCResumeComplete signaling, the first information unit can be named based on a corresponding first RRC signaling, which is not limited by the present disclosure. The designated information unit can also adopt other names, and the present disclosure is also not limited thereto.

In the embodiments, the unmanned aerial vehicle can report, by the first information unit in the first RRC signaling, the first notification message to the base station to notify the base station that the unmanned aerial vehicle has flight path information, so that the base station can obtain complete flight path information from the unmanned aerial vehicle, thereby the feasibility of providing services for the unmanned aerial vehicle by the cellular network is improved.

In some embodiments, an information transmission method is provided. FIG. 4 is a flowchart illustrating the information transmission method according to an embodiment of the present disclosure. The method is performed by the unmanned aerial vehicle. As shown in FIG. 4, the method can include the following steps 401 to 403.

At step S401, a first notification message is reported to a base station, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the unmanned aerial vehicle may report the first notification message to the base station during the establishment of a RRC connection with the base station, and the first notification message is configured to notify the base station that the flight path information is stored on the unmanned aerial vehicle.

The specific implementation can be similar to step 301 mentioned above, and will not be repeated here.

At step 402, a request message transmitted by the base station is received, where the request message is configured to request the unmanned aerial vehicle to report the flight path information.

In this embodiment, the base station, based on the first notification message reported by the unmanned aerial vehicle, determines that the unmanned aerial vehicle stores the flight path information, and transmits the request message to the unmanned aerial vehicle. The request message is configured to request the unmanned aerial vehicle to report the flight path information.

In some embodiments, the unmanned aerial vehicle can receive the request message transmitted, through second RRC signaling, by the base station.

In some embodiments, the second RRC signaling is terminal information request (e.g., UEInformationRequest) signaling.

At step 403, the flight path information is reported, based on the request message, to the base station.

In some embodiments, the unmanned aerial vehicle reports, by the third RRC signaling, the flight path information to the base station.

The third RRC signaling may be performed in response to the second RRC signaling. However, it is to be understood that transmitting the third RRC signaling to the base station by the unmanned aerial vehicle may be independent of receiving the second RRC signaling, that is, the unmanned aerial vehicle can autonomously transmit the third RRC signaling to the base station after notifying the base station that the unmanned aerial vehicle stores the flight path information. For example, within a preset time period after the unmanned aerial vehicle reports the first notification message to the base station via the first RRC signaling to notify the base station that the unmanned aerial vehicle stores the flight path information, the unmanned aerial vehicle may report the flight path information to the base station via the third RRC signaling. In some embodiments, the second RRC signaling is UEInformationRequest signaling, and the third RRC signaling is terminal information response (e.g., UEInformationResponse) signaling.

In this embodiment, the unmanned aerial vehicle can report the first notification message to the base station to notify the base station that the unmanned aerial vehicle stores the flight path information, so as to report the flight path information to the base station based on the request message transmitted by the base station, so that the base station can obtain complete flight path information from the unmanned aerial vehicle, thereby the feasibility of providing services for the unmanned aerial vehicle by the cellular network is improved.

In some embodiments, the base station transmits the request message to the unmanned aerial vehicle via a second RRC signaling. The second RRC signaling may carry configuration information configured by the base station for the unmanned aerial vehicle to report the flight path information.

The configuration information may be configured to indicate at least one of: a maximum number of path points allowed to be reported by the unmanned aerial vehicle; or a time stamp of the unmanned aerial vehicle at each path point.

In some embodiments, the time stamp may be associated with each path point.

In some embodiments, the configuration information may also be configured to indicate the flight altitude of the unmanned aerial vehicle at each path point, and the present disclosure is not limited thereto.

After receiving the second RRC signaling, the unmanned aerial vehicle can report the flight path information to the base station as indicated by the configuration information. In some embodiment, the number of path points corresponding to the flight path information reported by the unmanned aerial vehicle is less than or equal to the maximum number of path points configured by the base station, and/or the unmanned aerial vehicle reports the time stamp of arrival at each path point. In some embodiments, the unmanned aerial vehicle can also report to the base station the flight altitude at which the unmanned aerial vehicle reaches each path point, based on the configuration information.

In some embodiments, the configuration information may be carried in a second information unit of the second RRC signaling, and the second information unit may be an information unit newly introduced by the protocol for configuring the unmanned aerial vehicle to report the flight path information. In some embodiments, the second information unit may be a FlightPathInfoReportConfig information unit.

In the case that the second RRC signaling is UEInformationRequest signaling, the configuration information is transmitted via the second information unit (e.g., FlightPathInfoReportConfig) in the second RRC signaling, and the implementation is as follows:

UEInformationRequest message

-- ASN1START
-- TAG-UEINFORMATIONREQUEST-START

| | |
|---|---|
| UEInformationRequest-r16 ::= | SEQUENCE { |
| rrc-TransactionIdentifier | RRC-TransactionIdentifier, |
| criticalExtensions | CHOICE { |
| ueInformationRequest-r16 | UEInformationRequest-r16-IEs, |
| criticalExtensionsFuture | SEQUENCE { } |

}
}
UEInformationRequest-r16-IEs ::= SEQUENCE {

| | | |
|---|---|---|
| idleModeMeasurementReq-r16 | ENUMERATED{true} | OPTIONAL, -- Need N |
| logMeasReportReq-r16 | ENUMERATED {true} | OPTIONAL, -- Need N |
| connEstFailReportReq-r16 | ENUMERATED {true} | OPTIONAL, -- Need N |
| ra-ReportReq-r16 | ENUMERATED {true} | OPTIONAL, -- Need N |
| rlf-ReportReq-r16 | ENUMERATED {true} | OPTIONAL, -- Need N |
| mobilityHistoryReportReq-r16 | ENUMERATED {true} | OPTIONAL, -- Need N |
| lateNonCriticalExtension | OCTET STRING | OPTIONAL, |
| nonCriticalExtension | UEInformationRequest-v1700-IEs | OPTIONAL |

}
UEInformationRequest-v1700-IEs ::= SEQUENCE {

| | | |
|---|---|---|
| successHO-ReportReq-r17 | ENUMERATED {true} | OPTIONAL, -- Need N |
| nonCriticalExtension | UEInformationRequest-v1800-IEs | OPTIONAL |

}
UEInformationRequest-v1800-IEs ::= SEQUENCE {

| | | |
|---|---|---|
| flightPathInfoReq-r18 | FlightPathInfoReportConfig-r18 | OPTIONAL, -- Need N |
| nonCriticalExtension | SEQUENCE { } | OPTIONAL |

}
-- TAG-UEINFORMATIONREQUEST-STOP
-- ASN1STOP

The embodiment is only an exemplary illustration, and any solution for configuring the unmanned aerial vehicle to report the flight path information via RRC signaling in practical applications shall fall within the scope of protection of the present disclosure.

In some embodiments, the unmanned aerial vehicle reports, by the third RRC signaling, the flight path information to the base station.

The third RRC signaling may be UEInformationResponse signaling.

In some embodiments, the unmanned aerial vehicle reports, by the third information unit of the third RRC signaling, the flight path information to the base station. The third information unit can be configured to report the flight path information, and in some embodiments, the third information unit can be a FlightPathInfoReport information unit.

In the embodiments, the unmanned aerial vehicle can receive the request message transmitted by the base station through the second RRC signaling, the second RRC signaling carries the configuration information. Based on the indication of the configuration information, the unmanned aerial vehicle reports the flight path information to the base station through the third RRC signaling, so that the base station can obtain the complete flight path information, and the feasibility of providing services to the unmanned aerial vehicle through cellular networks is improved.

In some embodiments, the base station transmits the request message to the unmanned aerial vehicle through a second RRC signaling, to request the unmanned aerial vehicle to report the flight path information. The second RRC signaling carries configuration information, and the configuration information is at least configured to indicate the maximum number of path points allowed to be reported by the unmanned aerial vehicle.

In some embodiments, in a case that in response to a total number of path points corresponding to the flight path information stored by the unmanned aerial vehicle is greater than the maximum number of path points, the unmanned aerial vehicle reports the flight path information corresponding to the maximum number of path points to the base station.

In the embodiments, in order to ensure that the base station can obtain the complete flight path information, the unmanned aerial vehicle can report a second notification message to the base station while reporting the flight path information corresponding to the maximum number of path points. The second notification message is configured to notify the base station that the unmanned aerial vehicle stores unreported flight path information.

In some embodiments, the unmanned aerial vehicle reports the flight path information corresponding to the maximum number of path points to the base station through a third RRC signaling, and the second notification message can be directly carried in the third RRC signaling.

In some embodiments, the third RRC signaling may be UEInformationResponse signaling.

In some embodiments, the unmanned aerial vehicle reports, by a designated information unit in the third information unit of the third RRC signaling, the second notification message to the base station.

The third information unit can be configured to report the flight path information, and for example, the third information unit can be a FlightPathInfoReport information unit. The designated information unit is configured to indicate that the flight path information is available, and in some embodiments, the designated information unit may be a flightPathInfoAvailable-r18 information unit. In some embodiments, the designated information unit is of enumerated type.

It is to be noted that if the upper level information unit of the designated information unit is the first information unit in the first RRC signaling, the base station can determine the receipt of the first notification message based on the designated information unit, that is, determine that the unmanned aerial vehicle stores the flight path information. If the upper level information unit of the designated information unit is the third information unit in the third RRC signaling, the base station can determine the receipt of the second notification message, that is, determine that the unmanned aerial vehicle stores unreported flight path information in addition to the currently reported flight path information corresponding to the maximum number of path points.

In the case that the third RRC signaling is UEInformationResponse signaling. The specific implementation of transmitting the second notification message to the base station through the designated information unit (e.g., flightPathInfoAvailable-r18) in the third information unit (e.g., FlightPathInfoReport) of the third RRC signaling is as follows:

| UEInformationResponse-v1700-IEs ::= | SEQUENCE { | |
|---|---|---|
| successHO-Report-r17 | SuccessHO-Report-r17 | OPTIONAL, |
| connEstFailReportList-r17 | ConnEstFailReportList-r17 | OPTIONAL, |
| nonCriticalExtension | UEInformationResponse-v1700-IEs | OPTIONAL |

}

| UEInformationResponse-v1800-IEs ::= | SEQUENCE { | |
|---|---|---|
| flightPathInfoReport-r18 | FlightPathInfoReport-r18 | OPTIONAL, |
| nonCriticalExtension | SEQUENCE { } | OPTIONAL |

}

| FlightPathInfoReport-r18 ::= | SEQUENCE { | |
|---|---|---|
| flightPath-r18 SEQUENCE (SIZE (1..maxWayPoint-r18)) OF WayPointLocation-r18 | | OPTIONAL, |
| flightPathInfoAvailable-r18 | ENUMERATED {true} | OPTIONAL, |
| dummy | SEQUENCE { } | OPTIONAL |

}

| WayPointLocation-r18 ::= | SEQUENCE { | |
|---|---|---|
| wayPointLocation-r18 | LocationInfo-r10, | |
| timeStamp-r18 | AbsoluteTimeInfo-r10 | OPTIONAL |

}

In the embodiments, the unmanned aerial vehicle can report the flight path information corresponding to the maximum number of path points to the base station when the total number of path points corresponding to the stored flight path information is greater than the maximum number of path points. At the same time, the second notification message is transmitted to the base station to determine that the unmanned aerial vehicle still stores unreported flight path information, and it is ensured that the base station can obtain the complete flight path information and the high availability is ensured.

In some embodiments, an information transmission method is provided. FIG. 5 is a flowchart illustrating the information transmission method according to an embodiment of the present disclosure. The method is performed by the unmanned aerial vehicle. As shown in FIG. 5, the method can include the following step 501.

At step 501, a request message transmitted by the base station is received, where the request message is configured to request the unmanned aerial vehicle to report the flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In the embodiments, the base station may transmit the request message to the unmanned aerial vehicle after establishing an RRC connection with the unmanned aerial vehicle.

In some embodiments, the unmanned aerial vehicle can receive the request message transmitted, through second RRC signaling, by the base station.

In some embodiments, the second RRC signaling is UEInformationRequest signaling.

In some embodiments, the base station transmits the request message to the unmanned aerial vehicle via a second RRC signaling. The second RRC signaling may carry configuration information configured by the base station for the unmanned aerial vehicle to report the flight path information.

The configuration information may be configured to indicate at least one of: a maximum number of path points allowed to be reported by the unmanned aerial vehicle; or a time stamp of the unmanned aerial vehicle at each path point.

In some embodiments, the time stamp may be associated with each path point.

In some embodiments, the configuration information may also be configured to indicate the flight altitude of the unmanned aerial vehicle at each path point, and the present disclosure is not limited thereto.

In some embodiments, the configuration information may be carried in a second information unit of the second RRC signaling, and the second information unit may be an information unit newly introduced by the protocol for configuring the unmanned aerial vehicle to report the flight path information. In some embodiments, the second information unit may be a FlightPathInfoReportConfig information unit.

In the case that the second RRC signaling is UEInformationRequest signaling, the configuration information is transmitted via the second information unit (e.g., FlightPathInfoReportConfig) in the second RRC signaling, the implementation is described in the foregoing embodiments, and will not be repeated here.

In the embodiments, the unmanned aerial vehicle can receive the request message transmitted by the base station, and based on the request message, determine that the base station expects to obtain the flight path information of the unmanned aerial vehicle, which is easy to implement and highly usable.

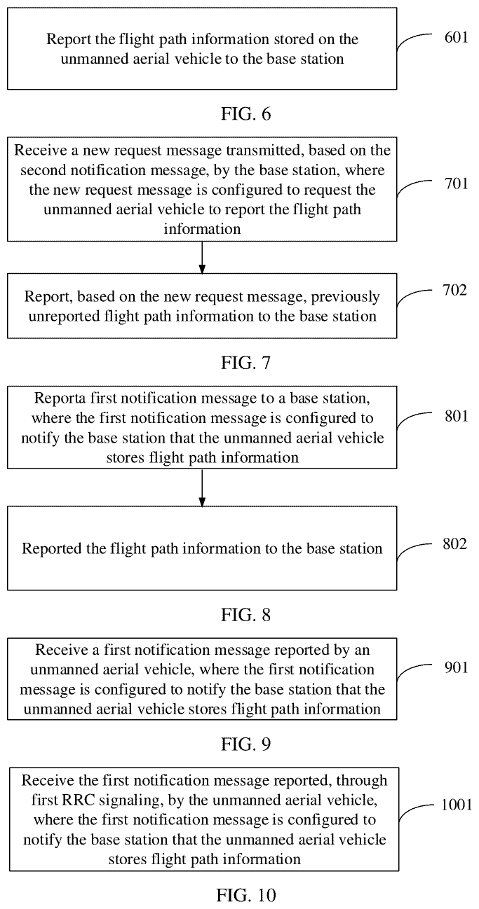

In some embodiments, an information transmission method is provided. FIG. 6 is a flowchart illustrating the information transmission method according to an embodiment of the present disclosure. The method is performed by the unmanned aerial vehicle. As shown in FIG. 6, the method can include the following step 601.

At step 601, the flight path information stored on the unmanned aerial vehicle is reported to the base station.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the unmanned aerial vehicle reports, by the third RRC signaling, the flight path information to the base station.

In some embodiments, the third RRC signaling may be UEInformationResponse signaling. In some embodiments, the third RRC signaling may also be other RRC signaling, and the present disclosure is not limited thereto.

In some embodiments, the unmanned aerial vehicle reports, by the third information unit of the third RRC signaling, the flight path information to the base station. The third information unit can be configured to report the flight path information, and in some embodiments, the third information unit can be a FlightPathInfoReport information unit.

In the embodiments, the unmanned aerial vehicle can directly report the flight path information stored on the unmanned aerial vehicle to the base station, such that the feasibility of providing services for the unmanned aerial vehicle by the cellular network is improved.

In some embodiments, step 501 may be combined with step 601, i.e., after the unmanned aerial vehicle receives a request message from the base station for requesting the unmanned aerial vehicle to report the flight path information, the unmanned aerial vehicle performs, based on the request message, step 601 to report to the base station the flight path information stored by the unmanned aerial vehicle.

If there is no flight path information on the unmanned aerial vehicle, the step of reporting flight path information may not be performed.

In some embodiments, if the unmanned aerial vehicle receives the request message via the second RRC signaling and the second RRC signaling carries configuration information, the unmanned aerial vehicle may report the flight path information to the base station via the third RRC signaling based on the indication of the configuration information.

In a case that in response to a total number of path points corresponding to the flight path information stored by the unmanned aerial vehicle is greater than the maximum number of path points, the unmanned aerial vehicle reports the flight path information corresponding to the maximum number of path points to the base station.

In the embodiments, in order to ensure that the base station can obtain the complete flight path information, the unmanned aerial vehicle can report a second notification message to the base station while reporting the flight path information corresponding to the maximum number of path points. The second notification message is configured to notify the base station that the unmanned aerial vehicle stores unreported flight path information.

In some embodiments, the unmanned aerial vehicle reports, by a designated information unit in the third information unit of the third RRC signaling, the second notification message to the base station.

The third information unit can be configured to report the flight path information, and for example, the third information unit can be a FlightPathInfoReport information unit. The designated information unit is configured to indicate that the flight path information is available, and in some embodiments, the designated information unit may be a flightPathInfoAvailable-r18 information unit. In some embodiments, the designated information unit is of enumerated type.

It is to be noted that if the upper level information unit of the designated information unit is the first information unit in the first RRC signaling, the base station can determine the receipt of the first notification message based on the designated information unit, that is, determine that the unmanned aerial vehicle stores the flight path information. If the upper level information unit of the designated information unit is the third information unit in the third RRC signaling, the base station can determine the receipt of the second notification message, that is, determine that the unmanned aerial vehicle stores unreported flight path information in addition to the currently reported flight path information corresponding to the maximum number of path points.

In the case that the third RRC signaling is UEInformationResponse signaling, the specific implementation of transmitting the second notification message to the base station through the designated information unit (e.g., flightPathInfoAvailable-r18) in the third information unit (e.g., FlightPathInfoReport) of the third RRC signaling is described in the foregoing embodiments, and will not be repeated here.

In the embodiments, the unmanned aerial vehicle can, after receiving the request message transmitted by the base station, report to the base station the flight path information stored by the unmanned aerial vehicle, thereby ensuring that the base station can obtain the complete flight path information, and the availability is high.

In some embodiments, an information transmission method is provided. FIG. 7 is a flowchart illustrating the information transmission method according to an embodiment of the present disclosure. The method is performed by the unmanned aerial vehicle. As shown in FIG. 7, the method can include the following steps 701 and 702.

At step 701, a new request message transmitted, based on the second notification message, by the base station is received, where the new request message is configured to request the unmanned aerial vehicle to report the flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In the embodiments, the unmanned aerial vehicle can transmit a second notification message to the base station to notify the base station that the unmanned aerial vehicle stores unreported flight path information when the total number of path points corresponding to the stored flight path information is greater than the maximum number of path points.

The base station can transmit a new request message to the unmanned aerial vehicle through the second RRC signaling based on the second notification message, and the new request message is configured to request the unmanned aerial vehicle to report the flight path information again.

In some embodiments, the second RRC signaling is UEInformationRequest signaling.

In some embodiments, the second RRC signaling carries configuration information configured by the base station for the unmanned aerial vehicle to report the flight path information.

The configuration information may be configured to indicate at least one of: a maximum number of path points allowed to be reported by the unmanned aerial vehicle; or a time stamp of the unmanned aerial vehicle at each path point.

At step 702, the flight path information is reported, based on the new request message, to the base station.

In the embodiments, the unmanned aerial vehicle can report the previously unreported flight path information to the base station based on the received new request message.

In some embodiments, the unmanned aerial vehicle reports, by the third RRC signaling, the previously unreported flight path information to the base station. The third RRC signaling may be UEInformationResponse signaling.

In some embodiments, the unmanned aerial vehicle reports, by the third information unit of the third RRC signaling, the flight path information to the base station. The third information unit can be configured to report the flight path information, and in some embodiments, the third information unit can be a FlightPathInfoReport information unit.

In the embodiments, if the number of path points corresponding to the previously unreported flight path information of the unmanned aerial vehicle is still greater than the maximum unmanned aerial vehicle indicated by the base station through configuration information, the unmanned aerial vehicle can transmit a second notification message to the base station again.

The steps 701 to 702 are repeated until the unmanned aerial vehicle reports the complete flight path information to the base station, i.e., until the unmanned aerial vehicle no longer reports the second notification message to the base station.

In the embodiments, it can be ensured that the base station effectively obtains the complete flight path information of the unmanned aerial vehicle, such that the feasibility of providing services for the unmanned aerial vehicle by the cellular network is improved.

In some embodiments, an information transmission method is provided. FIG. 8 is a flowchart illustrating the information transmission method according to an embodiment of the present disclosure. The method is performed by the unmanned aerial vehicle. As shown in FIG. 8, the method can include the following steps 801 and 802.

At step S801, a first notification message is reported to a base station, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the unmanned aerial vehicle may report the first notification message to the base station during the establishment of a RRC connection with the base station, and the first notification message is configured to notify the base station that the flight path information is stored on the unmanned aerial vehicle.

The specific implementation method can be similar to step 301 mentioned above, and will not be repeated here.

At step 802, the flight path information is reported to the base station.

In the embodiments, the unmanned aerial vehicle may report the flight path information directly to the base station without waiting for a request message from the base station after transmitting the first notification message to the base station.

The specific implementation is similar to the implementation of reporting the flight path information in the foregoing embodiments and will not be repeated here.

In the embodiments, when the unmanned aerial vehicle starts a timer when transmitting the first notification message to the base station, and when the timer times out, the unmanned aerial vehicle defaults that the base station has received the first notification message, and the unmanned aerial vehicle may report the flight path information to the base station via the third RRC signaling. The timing duration of the timer may be a preset duration, which is not limited by the present disclosure.

The embodiments are only an exemplary illustration, and the unmanned aerial vehicle reporting the flight path information to the base station based on other triggering conditions after transmitting the first notification message will also fall within the scope of protection of the present disclosure.

In this embodiment, the unmanned aerial vehicle can report the first notification message to the base station to notify the base station that the unmanned aerial vehicle stores the flight path information, so as to report the flight path information to the base station, so that the base station can obtain complete flight path information from the unmanned aerial vehicle, thereby the feasibility of providing services for the unmanned aerial vehicle by the cellular network is improved.

It is to be understood that the steps in the embodiments can be implemented separately or in combination, and the present disclosure is not limited thereto.

The following describes the information transmission method provided by the present disclosure from the base station side.

An embodiment of the present disclosure provides an information transmission method, the method can be performed by a base station, and the base station may a NR base station or a LTE base station. FIG. 9 is a flowchart illustrating the information transmission method according to the embodiment of the present disclosure. As shown in FIG. 9, the method can include the following step 901.

At step S901, a first notification message reported by an unmanned aerial vehicle is received, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the base station may receive the first notification message reported by the unmanned aerial vehicle during the establishment of a RRC connection with the unmanned aerial vehicle, and the first notification message is configured to notify the base station that the flight path information is stored on the unmanned aerial vehicle.

In the embodiments, the base station can receive the first notification message reported by the unmanned aerial vehicle to obtain complete flight path information from the unmanned aerial vehicle, thereby the feasibility of providing services for the unmanned aerial vehicle by the cellular network is improved.

In some embodiments, an information transmission method is provided. FIG. 10 is a flowchart illustrating the information transmission method according to an embodiment of the present disclosure. The method is performed by the base station. As shown in FIG. 10, the method can include the following step 1001.

At step S1001, a first notification message reported, through a first RRC signaling, by an unmanned aerial vehicle is received, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the base station may receive the first notification message reported by the unmanned aerial vehicle during the establishment of a RRC connection with the unmanned aerial vehicle, and the first notification message is configured to notify the base station that the flight path information is stored on the unmanned aerial vehicle.

In some embodiments, the base station may be a NR base station, or a LTE base station, which is not limited by the present disclosure.

In some embodiments, the base station is an NR base station, and accordingly, the first RRC signaling is any one of RRCReconfigurationComplete signaling; RRCReestablishmentComplete) signaling; RRCResumeComplete signaling; and RRCSetupComplete signaling.

In the embodiments, the base station can receive the first notification message reported, through the first RRC signaling, by the unmanned aerial vehicle to obtain complete flight path information from the unmanned aerial vehicle, thereby the feasibility of providing services for the unmanned aerial vehicle by the cellular network is improved.

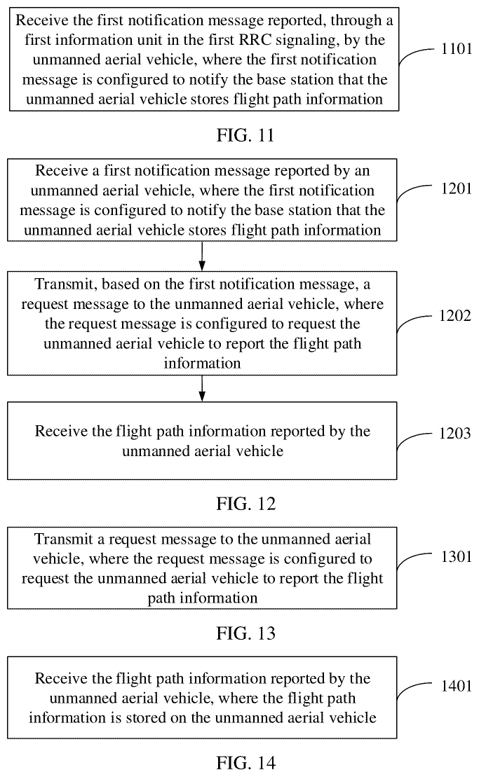

In some embodiments, an information transmission method is provided. FIG. 11 is a flowchart illustrating the information transmission method according to an embodiment of the present disclosure. The method is performed by the base station. As shown in FIG. 11, the method can include the following step 1101.

At step S1101, a first notification message reported, through a first information unit in the first RRC signaling, by an unmanned aerial vehicle is received, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the base station may receive the first notification message reported by the unmanned aerial vehicle during the establishment of a RRC connection with the unmanned aerial vehicle, and the first notification message is configured to notify the base station that the flight path information is stored on the unmanned aerial vehicle.

In some embodiments, the base station may be a NR base station, or a LTE base station, which is not limited by the present disclosure.

In some embodiments, the base station is an NR base station, and accordingly, the first RRC signaling is any one of RRCReconfigurationComplete signaling; RRCReestablishmentComplete) signaling; RRCResumeComplete signaling; and RRCSetupComplete signaling.

In some embodiment, the first information unit is an information element (IE) newly introduced in the protocol, and the first information unit may be related to flight path information. For example, the first RRC signaling is RRCSetupComplete signaling, and correspondingly, the first information unit can be RRCSetupComplete-v1800-IEs.

In some embodiment, the unmanned aerial vehicle can report the first notification message to the base station through a designated information unit in the first information unit. In a case that the base station determines that the designated information unit is included in the first information unit of the first RRC signaling, the base station determines that the first notification message is received, that is, it is determined that the unmanned aerial vehicle stores the flight path information.

In some embodiments, the designated information unit may be configured to indicate that the flight path information is available. In some embodiments, the designated information unit may be a flightPathInfoAvailable-r18 information unit.

In some embodiments, the designated information unit is of enumerated type.

In the case that the first RRC signaling is RRCSetupComplete signaling, the first notification message is reported to the base station through the designated information unit (e.g., flightPathInfoAvailable-r18) of enumerated type in the first information unit (e.g., RRCSetupComplete-v1800-IEs) of the first RRC signaling. The specific implementation is described on the unmanned aerial vehicle side and will not be repeated here.

In the embodiments, the base station can receive the first notification message reported, through the first information unit in the first RRC signaling, by the unmanned aerial vehicle to obtain complete flight path information from the unmanned aerial vehicle, thereby the feasibility of providing services for the unmanned aerial vehicle by the cellular network is improved.

In some embodiments, an information transmission method is provided. FIG. 12 is a flowchart illustrating the information transmission method according to an embodiment of the present disclosure. The method is performed by the base station. As shown in FIG. 12, the method can include the following steps 1201 to 1203.

At step S1201, a first notification message reported by an unmanned aerial vehicle is received, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

The specific implementation can be similar to step 1101 mentioned above, and will not be repeated here.

At step 1202, a request message is transmitted to the unmanned aerial vehicle based on the first notification message, where the request message is configured to request the unmanned aerial vehicle to report the flight path information.

In this embodiment, the base station, based on the first notification message reported by the unmanned aerial vehicle, determines that the unmanned aerial vehicle stores the flight path information, and transmits the request message to the unmanned aerial vehicle. The request message is configured to request the unmanned aerial vehicle to report the flight path information.

In some embodiments, the base station can transmit the request message through second RRC signaling.

In some embodiments, the second RRC signaling is UEInformationRequest signaling.

At step 1203, the flight path information reported by the unmanned aerial vehicle is received.

In some embodiments, the base station can receive the flight path information reported by the unmanned aerial vehicle through the third RRC signaling.

The third RRC signaling may be performed in response to the second RRC signaling. However, it is to be understood that transmitting the third RRC signaling to the base station by the unmanned aerial vehicle may be independent of receiving the second RRC signaling, that is, the unmanned aerial vehicle can autonomously transmit the third RRC signaling to the base station after notifying the base station that the unmanned aerial vehicle stores the flight path information. For example, within a preset time period after the unmanned aerial vehicle reports the first notification message to the base station via the first RRC signaling to notify the base station that the unmanned aerial vehicle stores the flight path information, the unmanned aerial vehicle may report the flight path information to the base station via the third RRC signaling.

In some embodiments, the second RRC signaling may be UEInformationRequest signaling, and the third RRC signaling may be UEInformationResponse signaling.

In the embodiments, the base station can receive the first notification message reported by the unmanned aerial vehicle to receive the flight path information reported by the unmanned aerial vehicle, so that the base station can obtain complete flight path information, thereby the feasibility of providing services for the unmanned aerial vehicle by the cellular network is improved.

In some embodiments, the base station transmits the request message to the unmanned aerial vehicle via a second RRC signaling. The second RRC signaling may carry configuration information configured by the base station for the unmanned aerial vehicle to report the flight path information.

The configuration information may be configured to indicate at least one of: a maximum number of path points allowed to be reported by the unmanned aerial vehicle; or a time stamp of the unmanned aerial vehicle at each path point.

In some embodiments, the time stamp may be associated with each path point.

In some embodiments, the configuration information may also be configured to indicate the flight altitude of the unmanned aerial vehicle at each path point, and the present disclosure is not limited thereto.

After receiving the second RRC signaling, the unmanned aerial vehicle can report the flight path information to the base station as indicated by the configuration information. In some embodiment, the number of path points corresponding to the flight path information reported by the unmanned aerial vehicle is less than or equal to the maximum number of path points configured by the base station, and/or the unmanned aerial vehicle reports the time stamp of arrival at each path point. In some embodiments, the unmanned aerial vehicle can also report to the base station the flight altitude at which the unmanned aerial vehicle reaches each path point, based on the configuration information.

In some embodiments, the configuration information may be carried in a second information unit of the second RRC signaling, and the second information unit may be an information unit newly introduced by the protocol for configuring the unmanned aerial vehicle to report the flight path information. In some embodiments, the second information unit may be a FlightPathInfoReportConfig information unit.

In the case that the second RRC signaling is UEInformationRequest signaling, the configuration information is transmitted via the second information unit (e.g., FlightPathInfoReportConfig) in the second RRC signaling, the implementation is described on the unmanned aerial vehicle side, and will not be repeated here.

In some embodiments, the base station can receive the flight path information reported by the unmanned aerial vehicle through the third RRC signaling.

The third RRC signaling may be UEInformationResponse signaling.

In some embodiments, the base station can receive the flight path information reported, through the third information unit of the third RRC signaling, by the unmanned aerial vehicle. The third information unit can be configured to report the flight path information, and in some embodiments, the third information unit can be a FlightPathInfoReport information unit.

In some embodiments, the base station can transmit the request message to the unmanned aerial vehicle through a second RRC signaling, to request the unmanned aerial vehicle to report the flight path information. The second RRC signaling carries configuration information, and the configuration information is at least configured to indicate the maximum number of path points allowed to be reported by the unmanned aerial vehicle.

In some embodiments, in a case that in response to a total number of path points corresponding to the flight path information stored by the unmanned aerial vehicle is greater than the maximum number of path points, the unmanned aerial vehicle reports the flight path information corresponding to the maximum number of path points to the base station.

In the embodiments, in order to ensure that the base station can obtain the complete flight path information, the unmanned aerial vehicle can report a second notification message to the base station while reporting the flight path information corresponding to the maximum number of path points. The second notification message is configured to notify the base station that the unmanned aerial vehicle stores unreported flight path information.

In some embodiments, the base station can receive the flight path information, corresponding to the maximum number of path points, reported, through the third RRC signaling, by the unmanned aerial vehicle, and the third RRC signaling carries a second notification message.

In some embodiments, the third RRC signaling may be UEInformationResponse signaling.

In some embodiment, when the base station determines that the third information unit of the third RRC signaling includes a designated information unit, it is determined that the second notification message is received, that is, it is determined that the unmanned aerial vehicle also stores unreported flight path information.

The third information unit can be configured to report the flight path information, and for example, the third information unit can be a FlightPathInfoReport information unit. The designated information unit is configured to indicate that the flight path information is available, and in some embodiments, the designated information unit may be a flightPathInfoAvailable-r18 information unit. In some embodiments, the designated information unit is of enumerated type.

It is to be noted that if the upper level information unit of the designated information unit is the first information unit in the first RRC signaling, the base station can determine the receipt of the first notification message based on the designated information unit, that is, determine that the unmanned aerial vehicle stores the flight path information. If the upper level information unit of the designated information unit is the third information unit in the third RRC signaling, the base station can determine the receipt of the second notification message, that is, determine that the unmanned aerial vehicle stores unreported flight path information in addition to the currently reported flight path information corresponding to the maximum number of path points.

In the case that the third RRC signaling is UEInformationResponse signaling, the specific implementation of transmitting the second notification message to the base station through the designated information unit (e.g., flightPathInfoAvailable-r18) in the third information unit (e.g., FlightPathInfoReport) of the third RRC signaling is described on the unmanned aerial vehicle side, and will not be repeated here.

In the embodiments, the base station can determine, based on the second notification message reported by the unmanned aerial vehicle, that the unmanned aerial vehicle stores unreported flight path information, it is ensured that the base station can obtain complete flight path information and the availability is high.

In some embodiments, an information transmission method is provided. FIG. 13 is a flowchart illustrating the information transmission method according to an embodiment of the present disclosure. The method is performed by the base station. As shown in FIG. 13, the method can include the following step 1301.

At step 1301, a request message is transmitted to the unmanned aerial vehicle, where the request message is configured to request the unmanned aerial vehicle to report the flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In the embodiments, the base station may transmit the request message to the unmanned aerial vehicle after establishing an RRC connection with the unmanned aerial vehicle.

In some embodiments, the base station can transmit the request message through second RRC signaling.

In some embodiments, the second RRC signaling is UEInformationRequest signaling.

In some embodiments, the base station transmits the request message to the unmanned aerial vehicle via a second RRC signaling. The second RRC signaling may carry configuration information configured by the base station for the unmanned aerial vehicle to report the flight path information.

The configuration information may be configured to indicate at least one of: a maximum number of path points allowed to be reported by the unmanned aerial vehicle; or a time stamp of the unmanned aerial vehicle at each path point.

In some embodiments, the time stamp may be associated with each path point.

In some embodiments, the configuration information may also be configured to indicate the flight altitude of the unmanned aerial vehicle at each path point, and the present disclosure is not limited thereto.

In some embodiments, the configuration information may be carried in a second information unit of the second RRC signaling, and the second information unit may be an information unit newly introduced by the protocol for configuring the unmanned aerial vehicle to report the flight path information. In some embodiments, the second information unit may be a FlightPathInfoReportConfig information unit.

In the case that the second RRC signaling is UEInformationRequest signaling, the configuration information is transmitted via the second information unit (e.g., FlightPathInfoReportConfig) in the second RRC signaling, the implementation is described in the foregoing embodiments, and will not be repeated here.

In the embodiments, the base station can transmit the request message to the unmanned aerial vehicle to obtain the flight path information of the unmanned aerial vehicle, which is easy to implement and highly available.

In some embodiments, an information transmission method is provided. FIG. 14 is a flowchart illustrating the information transmission method according to an embodiment of the present disclosure. The method is performed by the base station. As shown in FIG. 14, the method can include the following step 1401.

At step 1401, the flight path information reported by the unmanned aerial vehicle is received, where the flight path information is stored on the unmanned aerial vehicle.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the unmanned aerial vehicle reports, by the third RRC signaling, the flight path information to the base station.

In some embodiments, the third RRC signaling may be UEInformationResponse signaling. In some embodiments, the third RRC signaling may also be other RRC signaling, and the present disclosure is not limited thereto.

In some embodiments, the unmanned aerial vehicle reports, by the third information unit of the third RRC signaling, the flight path information to the base station. The third information unit can be configured to report the flight path information, and in some embodiments, the third information unit can be a FlightPathInfoReport information unit.

In the embodiments, the base station can receive the stored flight path information reported by the unmanned aerial vehicle, such that the feasibility of providing services for the unmanned aerial vehicle by the cellular network is improved.

In some embodiments, step 1301 may be combined with step 1401, i.e., after the base station a request message to the unmanned aerial vehicle for requesting the unmanned aerial vehicle to report the flight path information, the base station receives the stored flight path information reported, based on the request message, by the unmanned aerial vehicle. If there is no flight path information on the unmanned aerial vehicle, the base station will not receive the flight path information.

In some embodiments, if the unmanned aerial vehicle receives the request message via the second RRC signaling and the second RRC signaling carries configuration information, the unmanned aerial vehicle may report the flight path information to the base station via the third RRC signaling based on the indication of the configuration information.

In a case that in response to a total number of path points corresponding to the flight path information stored by the unmanned aerial vehicle is greater than the maximum number of path points, the unmanned aerial vehicle reports the flight path information corresponding to the maximum number of path points to the base station.

In the embodiments, in order to ensure that the base station can obtain the complete flight path information, the unmanned aerial vehicle can report a second notification message to the base station while reporting the flight path information corresponding to the maximum number of path points. The second notification message is configured to notify the base station that the unmanned aerial vehicle stores unreported flight path information.

In some embodiments, the unmanned aerial vehicle reports, by a designated information unit in the third information unit of the third RRC signaling, the second notification message to the base station.

The third information unit can be configured to report the flight path information, and for example, the third information unit can be a FlightPathInfoReport information unit. The designated information unit is configured to indicate that the flight path information is available, and in some embodiments, the designated information unit may be a flightPathInfoAvailable-r18 information unit. In some embodiments, the designated information unit is of enumerated type.

It is to be noted that if the upper level information unit of the designated information unit is the first information unit in the first RRC signaling, the base station can determine the receipt of the first notification message based on the designated information unit, that is, determine that the unmanned aerial vehicle stores the flight path information. If the upper level information unit of the designated information unit is the third information unit in the third RRC signaling, the base station can determine the receipt of the second notification message, that is, determine that the unmanned aerial vehicle stores unreported flight path information in addition to the currently reported flight path information corresponding to the maximum number of path points.

In the case that the third RRC signaling is UEInformationResponse signaling, the specific implementation of transmitting the second notification message to the base station through the designated information unit (e.g., flightPathInfoAvailable-r18) in the third information unit (e.g., FlightPathInfoReport) of the third RRC signaling is described in the foregoing embodiments, and will not be repeated here.

In the embodiments, the base station can transmit a request message to the unmanned aerial vehicle, so as to receive the stored flight path information reported, based on the request message, by the unmanned aerial vehicle, thereby it is ensured that the base station can obtain the complete flight path information, and the availability is high.

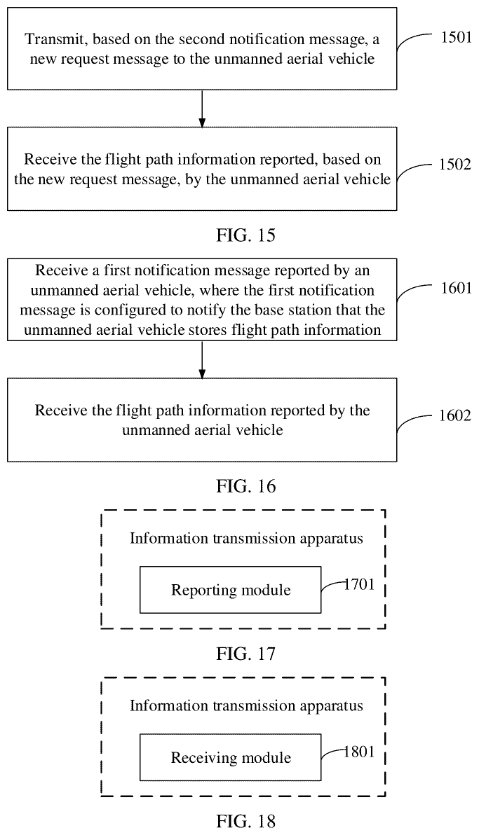

In some embodiments, an information transmission method is provided. FIG. 15 is a flowchart illustrating the information transmission method according to an embodiment of the present disclosure. The method is performed by the base station. As shown in FIG. 15, the method can include the following steps 1501 to 1502.

At step 1501, a new request message is transmitted to the unmanned aerial vehicle based on the second notification message.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In the embodiments, the unmanned aerial vehicle can transmit a second notification message to the base station to notify the base station that the unmanned aerial vehicle stores unreported flight path information when the total number of path points corresponding to the stored flight path information is greater than the maximum number of path points.

The base station can transmit a new request message to the unmanned aerial vehicle through the second RRC signaling based on the second notification message, and the new request message is configured to request the unmanned aerial vehicle to report the flight path information again.

In some embodiments, the second RRC signaling is UEInformationRequest signaling.

In some embodiments, the second RRC signaling carries configuration information configured by the base station for the unmanned aerial vehicle to report the flight path information.

The configuration information may be configured to indicate at least one of: a maximum number of path points allowed to be reported by the unmanned aerial vehicle; or a time stamp of the unmanned aerial vehicle at each path point.

At step 1502, the flight path information reported, based on the new request message, by the unmanned aerial vehicle is received.

In the embodiments, the base station can receive the flight path information reported, based on the new request message, by the unmanned aerial vehicle, this time the unmanned aerial vehicle reports the flight path information that is not reported last time.

In some embodiments, the base station may receive previously unreported flight path information reported, through third RRC signaling, by the unmanned aerial vehicle. The third RRC signaling may be UEInformationResponse signaling.

In some embodiments, the base station can receive the flight path information reported, through the third information unit of the third RRC signaling, by the unmanned aerial vehicle. The third information unit can be configured to report the flight path information, and in some embodiments, the third information unit can be a FlightPathInfoReport information unit.

In the embodiments, if the number of path points corresponding to the previously unreported flight path information of the unmanned aerial vehicle is still greater than the maximum unmanned aerial vehicle indicated by the base station through configuration information, the unmanned aerial vehicle can transmit a second notification message to the base station again.

The base station can repeat the steps 1501 to 1502 until the second notification message is no longer received.

In the embodiments, it can be ensured that the base station effectively obtains the complete flight path information of the unmanned aerial vehicle, such that the feasibility of providing services for the unmanned aerial vehicle by the cellular network is improved.

In some embodiments, an information transmission method is provided. FIG. 16 is a flowchart illustrating the information transmission method according to an embodiment of the present disclosure. The method is performed by the base station. As shown in FIG. 16, the method can include the following steps 1601 to 1602.

At step S1601, a first notification message reported by an unmanned aerial vehicle is received, where the first notification message is configured to notify the base station that the unmanned aerial vehicle stores flight path information.

It is to be understood that the flight path information may include, but is not limited to, path point information of path points that the unmanned aerial vehicle passes through, such as longitude and latitude coordinates of a path point, base station information corresponding to a path point, and a number of path points, and may also include a time stamp of the unmanned aerial vehicle at each path point, a flying height of the unmanned aerial vehicle at the path point, etc. The present disclosure is not limited thereto.

In some embodiments, the unmanned aerial vehicle may report the first notification message to the base station during the establishment of a RRC connection with the base station, and the first notification message is configured to notify the base station that the flight path information is stored on the unmanned aerial vehicle.

The specific implementation is described in the foregoing embodiments and will not be repeated here.

At step 1602, the flight path information reported by the unmanned aerial vehicle is received.

In the embodiments, the unmanned aerial vehicle may report the flight path information directly to the base station without waiting for a request message from the base station after transmitting the first notification message to the base station.

The specific implementation can be similar to the implementation of step 802 on the unmanned aerial vehicle side, and will not be repeated here.

In the embodiments, the base station can receive the first notification message reported by the unmanned aerial vehicle to receive the flight path information reported by the unmanned aerial vehicle, so that the base station can obtain complete flight path information, thereby the feasibility of providing services for the unmanned aerial vehicle by the cellular network is improved.

It is to be understood that the steps in the embodiments can be implemented separately or in combination, and the present disclosure is not limited thereto.

Corresponding to the foregoing method embodiments, the present disclosure further provides corresponding apparatuses embodiments.

FIG. 17 is a block diagram illustrating an information transmission apparatus according to an embodiment of the present disclosure. As shown in FIG. 17, the information transmission apparatus is applied to an unmanned aerial vehicle and includes a reporting module 1701.

The reporting module 1701 is configured to report a first notification message to a base station, where the first notification message is configured to notify the base station that the unmanned aerial vehicle stores flight path information.

FIG. 18 is a block diagram illustrating an information transmission apparatus according to an embodiment of the present disclosure. As shown in FIG. 18, the information transmission apparatus is applied to a base station and includes a receiving module 1801.

The receiving module 1801 is configured to receive a first notification message reported by an unmanned aerial vehicle, where the first notification message is configured to notify the base station that the unmanned aerial vehicle stores flight path information.

Since the embodiments of the apparatus substantially corresponds to the embodiments of the method, relevant parts may be referred to the description of the embodiments of the method. The apparatus examples described above are merely illustrative, where the units described as separate components may or may not be physically separated, and the components displayed as units may or may not be physical units, i.e., may be located in one place or may be distributed to multiple network units. Some or all of these modules can be selected according to actual needs to achieve the purpose of the solution of the present disclosure. It may be understood and implemented by those skilled in the art without creative work.

Correspondingly, the present disclosure provides a computer-readable storage medium, storing computer programs thereon, where the computer programs, when executed by a processor, cause the processor to perform the information transmission method of any one of the embodiments of the unmanned aerial vehicle side.

Correspondingly, the present disclosure provides a computer-readable storage medium, storing computer programs thereon, where the computer programs, when executed by a processor, cause the processor to perform the information transmission method of any one of the embodiments of the base station side.

Correspondingly, the present disclosure provides an information transmission device, and the information transmission device includes: a processor; and a memory storing instructions executable by the processor; where the instructions, when executed by the processor, cause the processor to perform the information transmission method of any one of the embodiments of the unmanned aerial vehicle side.

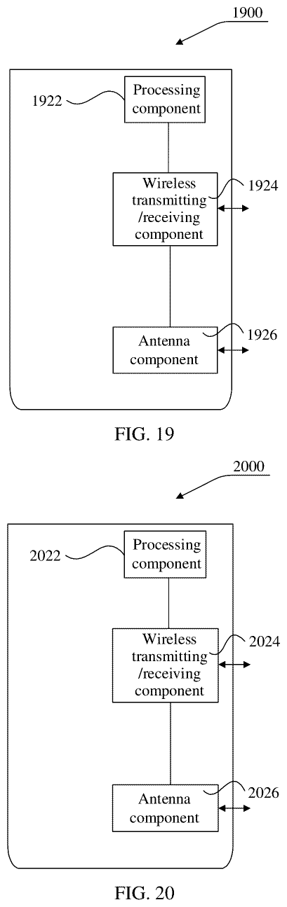

As illustrated in FIG. 19, FIG. 19 is a structural schematic diagram illustrating an information transmission device 1900 according to an embodiment of the present disclosure. The device 1900 may be provided as an unmanned aerial vehicle. Referring to FIG. 19, the device 1900 includes a processing component 1922, a wireless transmitting/receiving component 1924, an antenna component 1926, and a signal processing portion specific to a wireless interface. The processing component 1922 may further include one or more processors.

One of the processors in the processing component 1922 may be configured to execute the information transmission method of any one of the embodiments of the unmanned aerial vehicle side.

Correspondingly, the present disclosure provides an information transmission device, and the information transmission device includes: a processor; and a memory storing instructions executable by the processor; where the instructions, when executed by the processor, cause the processor to perform the information transmission method of any one of the embodiments of the base station side.

As illustrated in FIG. 20, FIG. 20 is a structural schematic diagram illustrating an information transmission device 2000 according to an embodiment of the present disclosure. The device 2000 may be provided as a base station. Referring to FIG. 20, the device 2000 includes a processing component 2022, a wireless transmitting/receiving component 2024, an antenna component 2026, and a signal processing portion specific to a wireless interface. The processing component 2022 may further include one or more processors.

One of the processors in the processing component 2022 may be configured to execute the information transmission method of any one of the embodiments of the base station side.

In the embodiments of the present disclosure, the unmanned aerial vehicle can report the first notification message to the base station to notify the base station that the unmanned aerial vehicle has flight path information, so that the base station can obtain complete flight path information from the unmanned aerial vehicle, thereby the feasibility of providing services for the unmanned aerial vehicle by the cellular network is improved.

After considering the specification and practicing the present disclosure, those skilled in the art would easily conceive of other implementations of the present disclosure. The present disclosure is intended to cover any variations, uses, modification or adaptations of the present disclosure that follow the general principles thereof and include common knowledge or conventional technical means in the related art that are not disclosed in the present disclosure. The specification and examples are considered as exemplary only, with a true scope and spirit of the present disclosure being indicated by the following claims.

It is to be understood that the present disclosure is not limited to the precise construction described herein and shown in the drawings, and that various modifications and changes may be made without departing from the scope thereof. The scope of the disclosure is to be limited only by the appended claims.

1. An information transmission method, performed by an unmanned aerial vehicle and comprising:
reporting a first notification message to a base station, wherein the first notification message is configured to notify the base station that the unmanned aerial vehicle stores flight path information.

2. The method of claim 1, wherein reporting the first notification message to the base station comprises:
reporting, by first radio resource control (RRC) signaling, the first notification message to the base station;
wherein the first RRC signaling is configured to be one of:
RRC reconfiguration complete signaling;
RRC reestablishment complete signaling;
RRC resume complete signaling; or
RRC setup complete signaling.

3. (canceled)

4. The method of claim 2, wherein reporting, by the first RRC signaling, the first notification message to the base station comprises:
reporting, by a designated information unit in a first information unit in the first RRC signaling, the first notification message to the base station, wherein the designated information unit is configured to indicate that the flight path information is available.

5. The method of claim 4, wherein the designated information unit is of enumerated type.

6. (canceled)

7. The method of claim 1, further comprising:
receiving a request message transmitted by the base station, wherein the request message is configured to request the unmanned aerial vehicle to report the flight path information; and
reporting, based on the request message, the flight path information to the base station.

8. The method of claim 7, wherein receiving the request message transmitted by the base station comprises:
receiving the request message transmitted, through second RRC signaling, by the base station, wherein the second RRC signaling is terminal information request signaling.

9. The method of claim 8, wherein the second RRC signaling carries configuration information for the unmanned aerial vehicle to report the flight path information;
wherein reporting the flight path information to the base station comprises:
reporting the flight path information to the base station as indicated by the configuration information.

10. The method of claim 9, wherein the configuration information is configured to indicate at least one of:
a maximum number of path points allowed to be reported by the unmanned aerial vehicle; or
a time stamp of the unmanned aerial vehicle at each path point.

11. (canceled)

12. (canceled)

13. The method of claim 7, wherein reporting the flight path information to the base station comprises:
reporting, by third RRC signaling, the flight path information to the base station, wherein the third RRC signaling is terminal information response signaling.

14. (canceled)

15. The method of claim 10, wherein reporting the flight path information to the base station comprises:
reporting the flight path information corresponding to the maximum number of path points to the base station in response to a total number of path points corresponding to the flight path information stored by the unmanned aerial vehicle being greater than the maximum number of path points;
wherein the method further comprises:
reporting a second notification message to the base station, wherein the second notification message is configured to notify the base station that the unmanned aerial vehicle stores unreported flight path information.

16. The method of claim 15, wherein the second notification message is carried in third RRC signaling, and the third RRC signaling is for the unmanned aerial vehicle to report the flight path information to the base station.

17. The method of claim 16, wherein reporting the second notification message to the base station comprises:
reporting, by a designated information unit in a third information unit of the third RRC signaling, the second notification message to the base station, wherein the third information unit is configured to report the flight path information, and the designated information unit is configured to indicate that the flight path information is available.

18. (canceled)

19. The method of claim 15, further comprising:
receiving a new request message transmitted, based on the second notification message, by the base station, wherein the new request message is configured to request the unmanned aerial vehicle to report the flight path information; and
reporting, based on the new request message, previously unreported flight path information to the base station.

20. An information transmission method, performed by a base station and comprising:
receiving a first notification message reported by an unmanned aerial vehicle, wherein the first notification message is configured to notify the base station that the unmanned aerial vehicle stores flight path information.

21.-25. (canceled)

26. The method of claim 20, further comprising:
transmitting, based on the first notification message, a request message to the unmanned aerial vehicle, wherein the request message is configured to request the unmanned aerial vehicle to report the flight path information; and
receiving the flight path information reported by the unmanned aerial vehicle.

27. (canceled)

28. (canceled)

29. The method of claim 6, wherein the request message carries configuration information for the unmanned aerial vehicle to report the flight path information, and the configuration information is configured to indicate at least one of:
a maximum number of path points allowed to be reported by the unmanned aerial vehicle; or
a time stamp of the unmanned aerial vehicle at each path point.

30.-33. (canceled)

34. The method of claim 29, further comprising:
receiving a second notification message reported by the unmanned aerial vehicle, wherein the second notification message is configured to notify the base station that the unmanned aerial vehicle stores unreported flight path information.

35.-37. (canceled)

38. The method of claim 34, further comprising:
transmitting, based on the second notification message, a new request message to the unmanned aerial vehicle, wherein the new request message is configured to request the unmanned aerial vehicle to report the flight path information; and
receiving the flight path information reported, based on the new request message, by the unmanned aerial vehicle.

39.-42. (canceled)

43. An information transmission device, comprising:
a processor; and
a memory storing instructions executable by the processor;
wherein the processor is configured to:
report a first notification message to a base station, wherein the first notification message is configured to notify the base station that an unmanned aerial vehicle stores flight path information.

44. An information transmission device, comprising:
a processor; and
a memory storing instructions executable by the processor;
wherein the processor is configured to perform the method of claim 20.
